(19) United States
(12) Patent Application Publication
(10) Pub. No.: US 2003/0167690 A1
(43) Pub. Date: Sep. 11, 2003

(54) Feedstock delivery system and fuel processing systems containing the same

(76) Inventors: David J. Edlund, Bend, OR (US); Arne LaVen, Bend, OR (US); Jeffrey R. Pledger, Bend, OR (US); Curtiss Renn, Bend, OR (US)

Correspondence Address: Kolisch, Hartwell, P.C., 520 S.W. Yamhill Street, Suite 200, Portland, OR, 97204, US

(21) Appl. No.: 10/379,496

(22) Filed: Mar. 3, 2003

Related U.S. Application Data
(60) Provisional application No. 60/362,237, filed on Mar. 5, 2002.
(60) Provisional application No. 60/400,901, filed on Aug. 1, 2002.

(51) Int. Cl. B01J 7/00

(52) U.S. Cl. 48/61; 422/112

(57) ABSTRACT

Feedstock delivery systems for fuel processors, and fuel processing systems incorporating the same. In some embodiments, the feedstock delivery system includes at least one pressurized tank or other reservoir that is adapted to store in liquid form a feedstock for a fuel processor. The delivery system further includes a pressurization assembly that is adapted to pressurize the reservoir by delivering a stream of pressurized gas thereto. In some embodiments, the gas is at least substantially comprised of nitrogen or other inert gases. In some embodiments, the gas is a nitrogen-enriched or a reduced-oxygen air stream. In some embodiments, the delivery system includes a sensor assembly that is adapted to monitor the concentration of oxygen in, and/or being delivered to, the reservoir(s). In some embodiments, the delivery system includes a pumpless delivery system that regulates the delivery under pressure of the feedstock from the tank to the fuel processor.

### RELATED APPLICATIONS

The present application claims priority to similarly entitled U.S. Provisional Patent Applications Serial Nos. 60/362,237 and 60/400,901, which were respectively filed on Mar. 5, 2002 and Aug. 1, 2002, and the complete disclosures of which are hereby incorporated by reference for all purposes.

### FIELD OF THE DISCLOSURE

The present disclosure relates generally to fuel processing and fuel cell systems, and more particularly to feedstock delivery systems for fuel processors.

### BACKGROUND OF THE DISCLOSURE

As used herein, the term “fuel processor” refers to a device that produces hydrogen gas from a feed stream that includes one or more feedstocks. Examples of fuel processors include steam and autothermal reformers, in which the feed stream contains water and a carbon-containing feedstock, such as an alcohol or a hydrocarbon, partial oxidation and pyrolysis reactors, in which the feed stream is a carbon-containing feedstock, and electrolyzers, in which the feed stream is water. The product hydrogen stream from a fuel processor may have a variety of uses, including forming a fuel stream for a fuel cell stack. A fuel cell stack receives fuel and oxidant streams and produces an electric current therefrom.

Conventionally, feedstocks such as alcohols and hydrocarbons are stored in tanks, from which pumps are used to draw the feedstock from the tank and deliver the feedstock under pressure to a fuel processor. A problem with the conventional delivery system is that pumps are relatively expensive and have relatively short life spans, with pumps often requiring replacement or rebuilding after less than 1000 hours of use, and often after several hundred hours of use. Because the pumps deliver the feedstock to conventional fuel processors, the pumps must be operational or else the fuel processing system cannot be used to produce hydrogen gas, and in the context of a fuel cell system, to produce an electric current therefrom.

### SUMMARY OF THE DISCLOSURE

The present disclosure is directed to feedstock delivery systems for fuel processors, and fuel processing systems incorporating the same. In some embodiments, the feedstock delivery system includes at least one pressurized tank or other reservoir that is adapted to store in liquid form a feedstock for a fuel processor. The delivery system further includes a pressurization assembly that is adapted to pressurize the reservoir by delivering a stream of pressurized gas thereto. In some embodiments, the gas is at least substantially comprised of nitrogen or other inert gases. In some embodiments, the gas is a nitrogen-enriched or a reduced-oxygen air stream. In some embodiments, the delivery system includes a sensor assembly that is adapted to monitor the concentration of oxygen in, and/or being delivered to, the reservoir(s). In some embodiments, the delivery system includes a pumpless delivery system that regulates the delivery under pressure of the feedstock from the tank to the fuel processor. Various other aspects of the disclosure will be described and illustrated in connection with the attached drawings and the following detailed description.

### BRIEF DESCRIPTION OF THE DRAWINGS

FIG. 1 is a schematic diagram of a fuel cell system containing a fuel processor and feedstock delivery system according to the present disclosure.

FIG. 2 is a schematic diagram of another embodiment of the fuel cell system of FIG. 1.

FIG. 3 is a schematic diagram of a fuel processor suitable for use in the fuel cell systems of FIGS. 1 and 2

FIG. 4 is a schematic diagram of another embodiment of the fuel processor of FIG. 3.

FIG. 5 is a schematic diagram of a fuel processing system that includes a feedstock delivery system according to the present disclosure.

FIG. 6 is a schematic diagram showing another fuel processing system that includes a feedstock delivery system according to the present disclosure.

FIG. 7 is a fragmentary schematic view showing another fuel processing system that includes a feedstock delivery system according to the present disclosure.

FIG. 8 is a schematic diagram showing another fuel processing system with a feedstock delivery system according to the present disclosure.

FIG. 9 is a schematic diagram of another feedstock delivery system according to the present disclosure.

FIG. 10 is a schematic diagram of another feedstock delivery system according to the present disclosure.

FIG. 11 is a schematic diagram of another feedstock delivery system according to the present disclosure.

FIG. 12 is a schematic diagram of another feedstock delivery system according to the present disclosure.

FIG. 13 is a schematic diagram of another feedstock delivery system according to the present disclosure.

FIG. 14 is a schematic diagram of another feedstock delivery system according to the present disclosure.

FIG. 15 is a schematic diagram of another feedstock delivery system according to the present disclosure.

FIG. 16 is a schematic diagram of another feedstock delivery system according to the present disclosure.

FIG. 17 is a fragmentary schematic diagram of a delivery regulator according to the present disclosure.

FIG. 18 is a fragmentary schematic diagram of another delivery regulator according to the present disclosure.

FIG. 19 is a fragmentary schematic diagram of another delivery regulator according to the present disclosure.

FIG. 20 is a fragmentary schematic diagram of another delivery regulator according to the present disclosure.

FIG. 21 is a schematic diagram of a fuel cell system that includes another feedstock delivery system according to the present disclosure.

### DETAILED DESCRIPTION AND BEST MODE OF THE DISCLOSURE

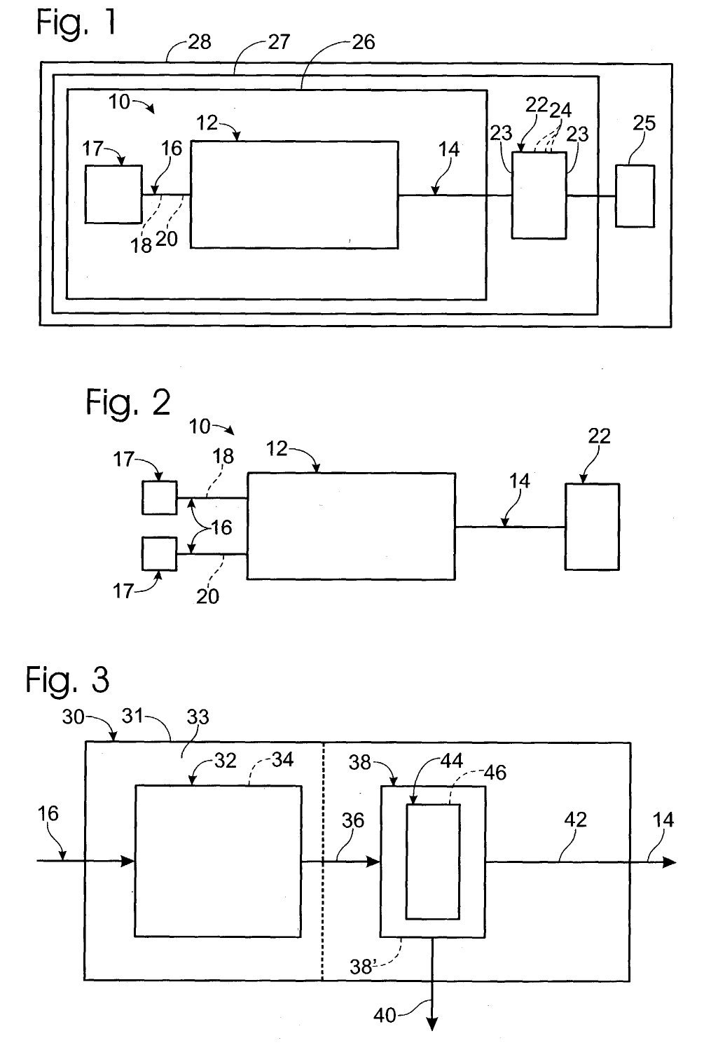

A fuel cell system according to the present disclosure is shown in FIG. 1 and generally indicated at 10. System 10 includes at least one fuel processor 12 and at least one fuel cell stack 22. Fuel processor 12 is adapted to produce a product hydrogen stream 14 containing hydrogen gas from a feed stream 16 containing at least one feedstock. The fuel cell stack is adapted to produce an electric current from the portion of product hydrogen stream 14 delivered thereto. In the illustrated embodiment, a single fuel processor 12 and a single fuel cell stack 22 are shown; however, it is within the scope of the disclosure that more than one of either or both of these components may be used. It should be understood that these components have been schematically illustrated and that the fuel cell system may include additional components that are not specifically illustrated in the figures, such as air delivery systems, heat exchangers, sensors, flow regulators, heating assemblies and the like.

Fuel processor 12 is any suitable device or assembly that produces from feed stream 16 a stream, such as product hydrogen stream 14, that is at least substantially comprises of hydrogen gas. Examples of suitable mechanisms for producing hydrogen gas from feed stream 16 include steam reforming and autothermal reforming, in which reforming catalysts are used to produce hydrogen gas from a feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Illustrative examples of suitable carbon-containing feedstocks include at least one hydrocarbon or alcohol. Illustrative examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream 16 may be delivered to fuel processor 12 via any suitable mechanism. Although only a single feed stream 16 is shown in FIG. 1, it is within the scope of the present disclosure that more than one stream 16 may be used and that these streams may contain the same or different feedstocks. When carbon-containing feedstock 18 is miscible with water, the feedstock is typically, but not required to be, delivered with the water component of feed stream 16, such as shown in FIG. 1. When the carbon-containing feedstock is immiscible or only slightly miscible with water, these feedstocks are typically delivered to fuel processor 12 in separate streams, such as shown in FIG. 2. In FIGS. 1 and 2, feed stream 16 is shown being delivered to fuel processor 12 by a feedstock delivery system 17, which will be discussed in more detail subsequently.

Fuel cell stack 22 contains at least one, and typically multiple, fuel cells 24 that are adapted to produce an electric current from the portion of the product hydrogen stream 14 delivered thereto. This electric current may be used to satisfy the energy demands, or applied load, of an associated energy-consuming device 25 that is adapted to apply a load on, or to, the fuel cell system. Illustrative examples of devices 25 include, but should not be limited to, any combination of one or more motor vehicles, recreational or industrial vehicles, boats or other seacraft, tools, lights or lighting assemblies, appliances (such as household or other appliances), computers, industrial equipment, household or office, signaling or communication equipment, etc. It should be understood that device 25 is schematically illustrated in FIG. 1 and is meant to represent one or more devices or collection of devices that are adapted to draw electric current from the fuel cell system.

A fuel cell stack typically includes multiple fuel cells joined together between common end plates 23, which contain fluid delivery/removal conduits. Illustrative examples of suitable types of fuel cells include phosphoric-acid fuel cells (PAFC), molten-carbonate fuel cells (MCFC), solid-oxide fuel cells (SOFC), alkaline fuel cells (AFC), and proton-exchange-membrane fuel cells (PEMFC, or PEM fuel cells). Occasionally PEM fuel cells are referred to as solid-polymer fuel cell (SPFC) because the membrane that separates the anode from the cathode is a polymer film that readily conducts protons, but is an electrical insulator. Fuel cell stack 22 may receive all of product hydrogen stream 14. Some or all of stream 14 may additionally, or alternatively, be delivered, via a suitable conduit, for use in another hydrogen-consuming process, burned for fuel or heat, or stored for later use. For example, system 10 may include at least one hydrogen storage device 13, as schematically illustrated in dashed lines in FIG. 1. Examples of suitable hydrogen storage devices include pressurized tanks and hydride beds. Similarly, system 10 may include at least one energy-storage device 15, as also indicated in dashed lines in FIG. 1. Examples of suitable energy-storage devices include batteries, ultra capacitors, and flywheels.

In many applications, it is desirable for the fuel processor to produce at least substantially pure hydrogen gas. Accordingly, the fuel processor may utilize a process that inherently produces sufficiently pure hydrogen gas, or the fuel processor may include suitable purification and/or separation devices or assemblies that remove impurities from the hydrogen gas produced in the fuel processor. As another example, the fuel processing system or fuel cell system may include purification and/or separation devices downstream from the fuel processor. In the context of a fuel cell system, the fuel processor preferably is adapted to produce substantially pure hydrogen gas, and even more preferably, the fuel processor is adapted to produce pure hydrogen gas. For the purposes of the present disclosure, substantially pure hydrogen gas is greater than 90% pure, preferably greater than 95% pure, more preferably greater than 99% pure, and even more preferably greater than 99.5% pure. Illustrative examples of suitable fuel processors are disclosed in U.S. Pat. Nos. 6,221,117, 5,997,594, 5,861,137, U.S. provisional patent application Serial No. 60/372,258, which as filed on Apr. 12, 2002 and is entitled “Steam Reforming Fuel Processor,” and pending U.S. patent application Ser. No. 09/802,361, which was filed on Mar. 8, 2001, published on Nov. 29, 2001 as U.S. Published Patent Application No. 20010045061, and is entitled “Fuel Processor and Systems and Devices Containing the Same.” The complete disclosures of the above-identified patents and patent applications are hereby incorporated by reference for all purposes.

For purposes of illustration, the following discussion will describe fuel processor 12 as a steam reformer adapted to receive a feed stream 16 containing a carbon-containing feedstock 18 and water 20. However, it is within the scope of the disclosure that fuel processor 12 may take other forms, as discussed above. An illustrative example of a suitable steam reformer is schematically illustrated in FIG. 3 and indicated generally at 30. Reformer 30 includes a hydrogen-producing region 32 in which a mixed gas stream 36 containing hydrogen gas is produced from feed stream 16. In the context of a steam reformer, the hydrogen-producing region may be referred to as a reforming region, the mixed gas stream may be referred to as a reformate stream, and the reforming region includes a steam reforming catalyst 34. Alternatively, reformer 30 may be an autothermal reformer that includes an autothermal reforming catalyst.

When it is desirable to purify the hydrogen in the mixed gas, or reformate stream, stream 36 is delivered to a separation region, or purification region, 38. In separation region 38, the hydrogen-containing stream is separated into one or more byproduct streams, which are collectively illustrated at 40 and which typically include at least a substantial portion of the other gases, and a hydrogen-rich stream 42, which contains at least substantially pure hydrogen gas. The separation region may utilize any separation process, including a pressure-driven separation process. In FIG. 3, hydrogen-rich stream 42 is shown forming product hydrogen stream 14.

An example of a suitable structure for use in separation region 38 is a membrane module 44, which contains one or more hydrogen permeable metal membranes 46. Examples of suitable membrane modules formed from a plurality of hydrogen-selective metal membranes are disclosed in U.S. Pat. No. 6,319,306, the complete disclosure of which is hereby incorporated by reference for all purposes. In the '306 patent, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in the above-incorporated patents and applications, as well as in U.S. patent application Ser. No. 10/067,275, which was filed on Feb. 4, 2002, is entitled “Hydrogen Purification Devices, Components and Fuel Processing Systems Containing the Same,” and U.S. patent application Ser. No. 10/257,509, which was filed on Dec. 19, 2001, is entitled “Hydrogen Purification Membranes, Components and Fuel Processing Systems Containing the Same. The complete disclosures of the above-identified patent applications are also hereby incorporated by reference for all purposes.

The thin, planar, hydrogen-permeable membranes are preferably composed of palladium alloys, most especially palladium with 35 wt % to 45 wt % copper, such as a palladium alloy containing approximately 40 wt % copper. These membranes, which also may be referred to as hydrogen-selective membranes, are typically formed from a thin foil that is approximately 0.001 inches thick, or less. It is within the scope of the present disclosure, however, that the membranes may be formed from hydrogen-selective metals and metal alloys other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations, which are disclosed in the incorporated patents.

Another example of a suitable pressure-separation process for use in separation region 38 is pressure swing adsorption (PSA). A separation region containing a pressure swing adsorption assembly is schematically illustrated at 47 in dash-dot lines in FIG. 3. In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 36.

The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities ate retained on the adsorbent material. The adsorbent bed periodically needs to be regenerated to remove these adsorbed impurities. Accordingly, pressure swing adsorption assemblies typically include a plurality of adsorbent beds so that at least one bed is configured to purify the mixed gas stream even if at least another one of the beds is not so-configured, such as if the bed is being regenerated, serviced, repaired, etc.

Impurity gases such as NH₃, H₂S, and H₂O adsorb very strongly on the adsorbent material and are therefore removed from stream 36 along with other impurities. If the adsorbent material is going to be regenerated and these impurities are present in stream 36, separation region 38 preferably includes a suitable device that is adapted to remove these impurities prior to delivery of stream 36 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It should be understood, however, that other suitable adsorbent material compositions, forms and configurations may be used.

From the preceding discussion, it should be apparent that byproduct stream 40 generally refers to the impurities that remain after hydrogen-rich stream is separated from the mixed gas stream. In some embodiments, this stream will be created as the hydrogen-rich stream is formed, such as in the context of membrane separation assemblies, while in other embodiments the stream is at least temporarily retained within the separation assembly, such as in the context of pressure swing adsorption assemblies.

As discussed, it is also within the scope of the disclosure that at least some of the purification of the hydrogen gas is performed intermediate the fuel processor and the fuel cell stack. Such a construction is schematically illustrated in dashed lines in FIG. 3, in which the separation region 38′ is depicted downstream from the shell 31 of the fuel processor. Therefore, it is within the scope of the present disclosure for the separation region to be at least partially, or even completely, contained within a common shell or otherwise integrated with the fuel processor, or for the separation region to be a separate, discrete structure that is in fluid communication with the fuel processor.

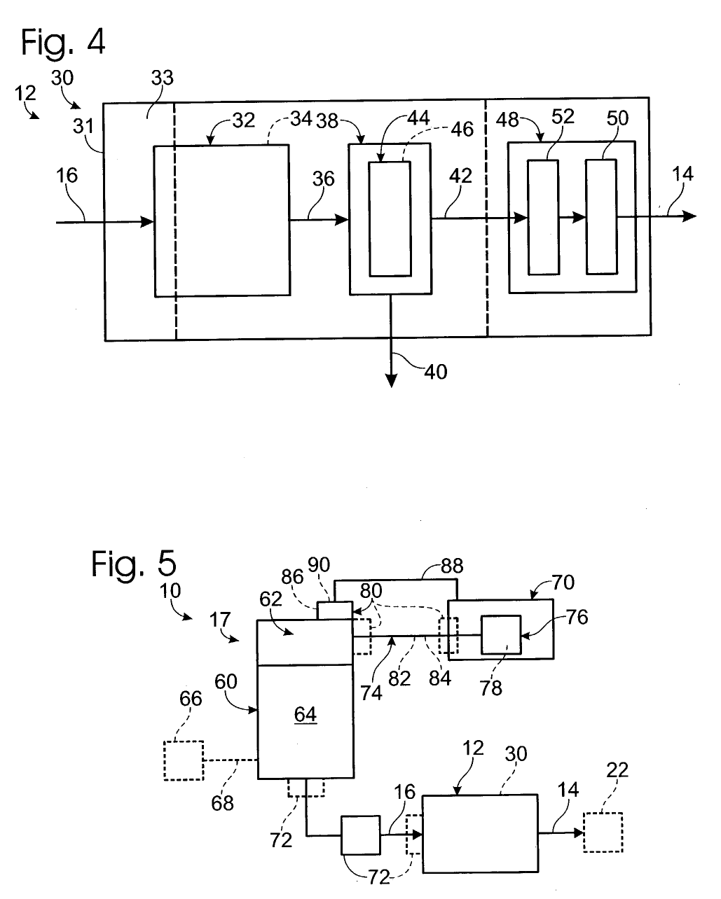

Reformer 30 (or other fuel processors 12) may, but does not necessarily, additionally or alternatively, include a polishing region 48, such as shown in FIG. 4. As shown, polishing region 48 receives hydrogen-rich stream 42 from separation region 38 and further purifies the stream by reducing the concentration of, or removing, selected compositions therein. For example, when stream 42 is intended for use in a fuel cell stack, such as stack 22, compositions that may damage the fuel cell stack, such as carbon monoxide and carbon dioxide, may be removed from the hydrogen-rich stream. The concentration of carbon monoxide should be less than 10 ppm (parts per million). Preferably, the system limits the concentration of carbon monoxide to less than 5 ppm, and even more preferably, to less than 1 ppm. The concentration of carbon dioxide may be greater than that of carbon monoxide. For example, concentrations of less than 25% carbon dioxide may be acceptable. Preferably, the concentration is less than 10%, and even more preferably, less than 1%. Especially preferred concentrations are less than 50 ppm. It should be understood that the acceptable maximum concentrations presented herein are illustrative examples, and that concentrations other than those presented herein may be used and are within the scope of the present disclosure. For example, particular users or manufacturers may require minimum or maximum concentration levels or ranges that are different than those identified herein. Similarly, when fuel processor 12 is not used with a fuel cell stack, or when it is used with a fuel cell stack that is more tolerant of these impurities, then the product hydrogen stream may contain larger amounts of these gases.

Region 48 includes any suitable structure for removing or reducing the concentration of the selected compositions in stream 42. For example, when the product stream is intended for use in a PEM fuel cell stack or other device that will be damaged if the stream contains more than determined concentrations of carbon monoxide or carbon dioxide, it may be desirable to include at least one methanation catalyst bed 50. Bed 50 converts carbon monoxide and carbon dioxide into methane and water, both of which will not damage a PEM fuel cell stack. Polishing region 48 also may (but is not required to) include another hydrogen-producing region 52, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

Steam reformers typically operate at temperatures in the range of 200° C. and 700° C., and at pressures in the range of 50 psi and 1000 psi, although temperatures and pressures outside of this range are within the scope of the disclosure, such as depending upon the particular type and configuration of fuel processor being used. Any suitable heating mechanism or device may be used to provide this heat, such as a heater, burner, combustion catalyst, or the like. The heating assembly may be external the fuel processor or may form a combustion chamber that forms part of the fuel processor. The fuel for the heating assembly may be provided by the fuel processing system, by the fuel cell system, by an external source, or both;

In FIGS. 3 and 4, reformer 30 is shown including a shell 31 in which the above-described components are contained. Shell 31, which also may be referred to as a housing, enables the fuel processor, such as reformer 30, to be moved as a unit. It also protects the components of the fuel processor from damage by providing a protective enclosure and reduces the heating demand of the fuel processor because the components of the fuel processor may be heated as a unit. Shell 31 may, but does not necessarily, include insulating material 33, such as a solid insulating material, blanket insulating material, or an air-filled cavity. The shell may include one or more constituent sections. When reformer 30 includes insulating material 33, the insulating material may be internal the shell, external the shell, or both. When the insulating material is external a shell containing the above-described reforming, separation and/or polishing regions, the fuel processor may further include an outer cover or jacket external the insulation. It is within also the scope of the disclosure, however, that the reformer may be formed without a housing or shell.

It is further within the scope of the disclosure that one or more of the components may either extend beyond the shell or be located external at least shell 31. For example, and as schematically illustrated in FIG. 4, polishing region 48 may be external shell 31 and/or a portion of reforming region 32 may extend beyond the shell. Other examples of fuel processors demonstrating these configurations are illustrated in the incorporated references and discussed in more detail herein.

Although fuel processor 12, feedstock delivery system 17, fuel cell stack 22 and energy-consuming device 25 may all be formed from one or more discrete components, it is also within the scope of the disclosure that two or more of these devices may be integrated, combined or otherwise assembled within an external housing or body. For example, a fuel processor and feedstock delivery system may be combined to provide a hydrogen-producing device with an onboard, or integrated, feedstock delivery system, such as schematically illustrated at 26 in FIG. 1. Similarly, a fuel cell stack may be added to provide an energy-generating device with an integrated feedstock delivery system, such as schematically illustrated at 27 in FIG. 1.

Fuel cell system 10 may additionally be combined with an energy-consuming device, such as device 25, to provide the device with an integrated, or on-board, energy source. For example, the body of such a device is schematically illustrated in FIG. 1 at 28. Examples of such devices include a motor vehicle, such as a recreational vehicle, automobile, industrial vehicle, boat or other seacraft, and the like, or self-contained equipment, such as an appliance, light, tool, microwave relay station, transmitting assembly, remote signaling or communication equipment, measuring or detection equipment, etc.

It is within the scope of the disclosure that the feedstock delivery system and fuel processor 12, such as reformer 30, may be used independent of a fuel cell stack. In such an embodiment, the system may be referred to as a fuel processing system, and it may be used to provide a supply of pure or substantially pure hydrogen to a hydrogen-consuming device, such as a burner for heating, cooking or other applications. Similar to the above discussion about integrating the fuel cell system with an energy-consuming device, the fuel processor and hydrogen-consuming device may be combined, or integrated.

In FIG. 5, a feedstock delivery system 17 according to the present disclosure is schematically illustrated. As shown, delivery system 17 is adapted to deliver a feed stream 16 to a fuel processor 12, which as discussed, produces product hydrogen stream 14 therefrom. This composite system may be referred to as a fuel processing system. As shown in dashed lines in FIG. 5, the system may include a fuel cell stack 22 that is adapted to receive at least a portion of the product hydrogen stream and to produce an electric current therefrom. Such a system may be referred to as a fuel cell system.

As schematically illustrated in FIG. 5, delivery system 17 includes a feedstock reservoir 60 that is adapted to store in liquid form a selected volume of One or more feedstocks that make up feed stream 16. Examples of suitable reservoirs include pressurized tanks, although any suitable vessel or device for storing a feedstock under the elevated pressures and other operating parameters discussed herein may be used. Reservoir 60 includes an internal compartment, or chamber, 62 in which the liquid-phase feedstock is stored. In the context of the following discussion relating to delivery system 17, reference numeral 64 will be used to generally indicate a feedstock, which as discussed, may include one or more of a carbon-containing feedstock and water. When the carbon-containing feedstock is miscible with water and the fuel processor requires a feed stream 16 that contains both water and a carbon-containing feedstock, the feedstock 64 may be a mixture of the carbon-containing feedstock and water. Although not required, this configuration enables a single reservoir 60 to be used to supply a complete steam, or autothermal, reforming feedstock.

Reservoir 60 may receive feedstock 64 through any suitable mechanism. For example, reservoir 60 may be charged with a volume of feedstock 64 and then connected to system 17. In such an embodiment, when the reservoir is empty or the volume of feedstock 64 is below a predetermined minimum volume, the reservoir will typically be disconnected from the system and replaced with a charged reservoir. Alternatively, the reservoir may be disconnected from the system, recharged, and then reconnected to the system. Another suitable mechanism for charging reservoir 60 is for the reservoir to be connected to one or more sources 66 of feedstock (or the components thereof) via a suitable fluid transport line 68, as schematically illustrated in dashed lines in FIG. 5. Illustrative examples of such sources include other, typically larger, reservoirs, supply lines, and the like. Accordingly, it should be understood that reservoir 60 will typically include suitable valves, meters, sensors, input connections and the like. For the purpose of simplifying the drawings, these components have not been separately illustrated and instead should be understood to be represented by the schematic depiction of reservoir 60.

System 17 differs from conventional feedstock delivery systems, which store the feedstock at or near atmospheric pressure and then require one or more pumps to draw feedstock 64 from reservoir 60 and deliver the feedstock to fuel processor 12 under pressure. In contrast, system 17 is adapted to store feedstock 64 under pressure in a liquid-phase and then deliver the pressurized feedstock from the reservoir to the fuel processor without requiring a conventional pump. This elevated pressure may provide, as an illustrative example, a pressure differential that may be used by a pressure-driven separation process to purify the mixed gas stream produced by the fuel processor. As such, system 17 includes a pressurization assembly 70, which includes any suitable structure for pressuring compartment 62 so that feedstock 64 is withdrawn therefrom under a selected elevated pressure. System 17 further includes a delivery regulator 72, which controls the flow of pressurized feedstock 64 from reservoir 60 to fuel processor 12.

Pressurization assembly 70 is adapted to maintain compartment 62 at a pressure of at least 25 psig, and typically at or above 50 psig. Examples of suitable pressure ranges include 50-250 psig, 75-225 psig and 100-200 psig. Although pressures that exceed 300 psig are within the scope of the disclosure, they typically will not be used. In particular, it is preferable that steam reforming be conducted at 100 psig to 300 psig. However, the desired pressure range for system 17 may vary, as discussed herein. For example, system 17 may be used with a fuel processor other than a steam reformer, and the system may be operated at a higher pressure to account for losses occurring between reservoir 60 and fuel processor 12. For most steam reforming applications, a delivery pressure in the range of 100 and 200 psig has proven effective, although others may be used and are within the scope of the disclosure.

Assembly 70 is adapted to pressurize the reservoir by delivering a stream 74 of gas under pressure thereto. Accordingly, assembly 70 includes a source 76 of pressurized gas 78 and a pressure regulator 80 that directly or indirectly regulates the pressure of (within) reservoir 60. In embodiments of system 17 in which reservoir 60 contains a carbon-containing feedstock, gas 78 preferably is either an inert gas 82, such as nitrogen gas, or nitrogen-enriched air 84. By “inert,” it is meant that the gas does not chemically react with the feedstock upon delivery of the gas to reservoir 60. Preferably, the inert gas is also selected to not be combustible or explosive under the operating parameters of the pressurization assembly and reservoir. By “nitrogen-enriched air,” it is meant that the gas has a lower concentration of oxygen gas and/or a higher concentration of nitrogen gas than is normally present in air. Accordingly, nitrogen-enriched air 84 may be comprised of air to which nitrogen gas has been added and/or from which oxygen gas has been removed. In view of the above, the nitrogen-enriched air may also be referred to as reduced-oxygen air. In context of a pressurization assembly that receives an air stream and produces the stream of nitrogen-enriched air therefrom, the nitrogen-enriched air stream may be described as having a higher concentration of nitrogen gas and/or a lower concentration of oxygen gas than the air stream from which the nitrogen-enriched air stream is formed.

Pressure regulator 80 may take a variety of forms. Preferably, but not necessarily, the pressure regulator maintains the pressure within reservoir 60 so that the pressure does not exceed predetermined upper and/or lower threshold pressures. For example, the regulator preferably maintains the pressure within the reservoir from being greater than an upper threshold, or upper pressure, such as by utilizing a pressure-relief valve 86 to reduce the pressure within the reservoir. The pressure regulator preferably also keeps the pressure from dropping below a lower threshold, or lower pressure, such as by increasing the supply of pressurized gas to the reservoir and/or increasing the pressure of the pressurized gas that is supplied to the reservoir. An illustrative mechanism for maintaining the pressure above a lower threshold is for regulator 80 to include a pressure sensor 90 that actuates the delivery of additional pressurized gas 78 if the pressure within reservoir 60 falls below a predetermined threshold.

The threshold values may be the actual minimum or maximum acceptable pressures within reservoir 60, or alternatively may be selected to be a determined increment, such as 2%, 5%, 10%, 20%, etc. less than the upper threshold or greater than the lower threshold. This selection of the threshold values essentially provides a buffer in which the system may reestablish or stabilize the pressure within the desired range.

Regulator 80 may include any suitable structure to accomplish the above-described function, and may include more than one discrete component, a series of interconnected, or intercommunicating, components, etc. Regulator 80 may include mechanical components, electronic components, and/or combinations thereof. When the regulator includes or is in communication with electronic components, it may include hardware components and/or a combination of both hardware and software components, such as a microprocessor that executes code or other software. In some embodiments, the regulator will include a memory device in which threshold values are stored. The memory device may also store performance data, operational code executable instructions, stored, or other programming, and other electronically implemented aspects of delivery system 17 and its control and/or feedback mechanisms. The memory device may include both volatile and nonvolatile regions. In FIG. 5, the pressure regulator is schematically illustrated in solid lines at 80 on reservoir 60 and in communication with pressurization assembly 70 via a communication linkage 88, which may be any suitable form of mechanical or electronic communication, including wired or wireless communication. However, it should be understood that regulator 80, or portions thereof, may be positioned in a variety of locations within system 17, or even fuel cell system 10. This is graphically illustrated in dashed lines in FIG. 5.

When a stream 74 containing nitrogen-enriched air 84 is used to pressurize the reservoir, the stream preferably has a composition that contains insufficient oxygen for the feedstock within reservoir 60 to be flammable and/or explosive under the pressurized conditions maintained therein. It should be understood that the flammable or explosive threshold of the pressurized carbon-containing feedstock and oxygen varies according to several different factors, and therefore will tend to vary from feedstock to feedstock. Examples of these factors include the composition of feedstock 64, the pressure at which the contents of reservoir 60 are maintained, the partial pressure of oxygen within compartment 62, the composition of gas 78, the vapor pressure of feedstock 64, the temperature within compartment 62, and the upper and/or lower explosive limits for the particular combination of feedstock 64 and the composition of air (i.e., unmodified, nitrogen-enriched, reduced-oxygen, etc).

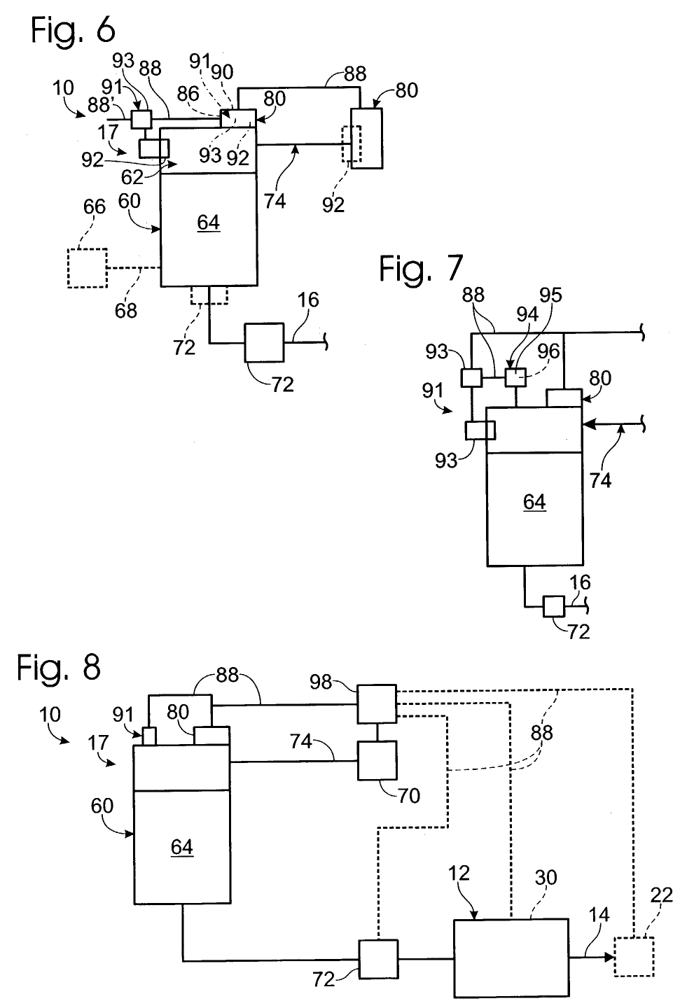

Although not required, pressurization assembly 70 may include a sensor assembly 91 that includes one or more sensors 92 that are adapted to measure the oxygen concentration (concentration of oxygen gas) within compartment 62 and/or in stream 74. An example of a feedstock delivery system 17 that contains a sensor assembly 91 is shown in FIG. 6. In solid lines, sensor assembly 91 is shown including a single sensor 92 within compartment 62. However, and as discussed, it is within the scope of the disclosure that more than one sensor 92 may be used and/or that the sensor assembly may include one or more sensors upstream from compartment 62. Examples of these additional and/or alternative sensor positions are indicated in dashed lines in FIG. 6. It is also within the scope of the disclosure that sensor assembly 91 may include one or more redundant sensors 92. Using two or more sensors provides an added level of safety or protection, such as if one of the sensors malfunctions or otherwise does not detect a concentration of oxygen gas that exceeds the flammable or explosive threshold of the feedstock within reservoir 60.

Sensors 92 may include any suitable structure for measuring the concentration of oxygen gas. The measured, or detected, value is compared to one or more threshold values to determine if the measured value exceeds the threshold value(s). If so, the pressure within reservoir(s) 60 is released. The reduction in the pressure within the reservoir raises the flammable or explosive threshold of the carbon-containing feedstock within the reservoir. Typically, upon detection of an oxygen concentration that exceeds the flammable or explosive threshold, the fuel cell (or fuel processing) system will also be shutdown. This shutdown may be manually actuated, but preferably is automatically actuated, such as by a controller that sends control signals to the appropriate components of the system to effect the shutdown.

Sensor assembly 91 may therefore include a dedicated controller 93 that, at least partially responsive to the detected, or measured, values from the sensor(s) 92, communicates via a suitable communication linkage 88 with pressure regulator 80 (or at least pressure relief valve 86 thereof), or with another pressure relief valve that is adapted to release pressure from the reservoir. Similarly, controller 93 may communicate with other components of the fuel cell or fuel processing system to actuate the controlled shutdown of the system. This is schematically illustrated in FIG. 6 with communication linkage 88′. Controller 93 may be adapted to compare the measured values to a single threshold value, such as a threshold value that is equal to or a selected increment below the flammable or explosive threshold of the feedstock within the pressurized reservoir. Examples of selected increments include 2%, 5%, 10%, 20% and 30% less than the threshold. It is also within the scope of the disclosure that more than one threshold value may be used. For example, a first threshold value, such as described above may be used, as well as a second threshold value that is lower than the first threshold value. A benefit of using a pair of threshold values is that the second threshold value may be used to initiate, or actuate, preventative steps to reduce the oxygen gas concentration in the reservoir. However, should these preventative steps not be effective at stopping the increase in oxygen gas concentration and the first threshold value is exceeded, then the controller may actuate depressurization of the reservoir and/or shutdown of the fuel processing (or fuel cell system).

Although shown in FIG. 6 as a separate structure from pressure regulator 80, it is within the scope of the disclosure that sensor assembly 91 may be at least partially, or even completely, integrated with the pressure regulator. This construction is schematically illustrated with dash-dot lines in FIG. 6. As discussed below, the pressure regulator is preferably in at least indirect communication with the sensor assembly.

Embodiments of the pressurization assembly that include a sensor assembly 91 may, but are not required to, further include an exhaust assembly 94 that is adapted to introduce an inert or otherwise combustion-inhibiting gas 95 into reservoir 60 upon actuation and depressurization of the reservoir. Examples of suitable gases include nitrogen gas, carbon dioxide, and/or chlorofluorocarbons, such as HALON™. An illustrative example of such an assembly 94 is schematically illustrated in FIG. 7. As shown, assembly 94 is in communication with controller 93 via a communication linkage 88 and includes a supply, or charge, 96 of gas 95. Upon receipt of a command signal corresponding to sensor assembly 93 detecting that the flammability or explosive threshold has been exceeded, assembly 94 delivers gas 95 into the reservoir.

In embodiments of system 17 that include a sensor assembly and/or pressure regulator that is/are computerized, or computer implemented, such as including at least one microprocessor, software executing on a processor, firmware, application specific integrated circuit, analog and/or digital circuit, etc., the computerized portions of the sensor assembly and/or regulator may form a portion of a controller for the feedstock delivery system, and/or other components of the fuel processing or fuel cell system, such as fuel processor 12 and fuel cell stack 22. This is illustrated schematically in FIG. 8, in which system 10 includes a controller 98 that is in at least one-way communication with suitable sensors, switches, valves, actuators and/or other measuring and/or control devices associated with reservoir 60, sensor assembly 91, pressure regulator 80, pressurization assembly 70, and delivery regulator 72. Controller 98 typically will include a processor with a memory device, such as any of the illustrative configurations described above. As shown in dashed lines in FIG. 8, the controller may also communicate with, and thereby receive inputs relating to the operating conditions of and/or send control signals to other components of systems 17 and 10, such as delivery regulator 72, fuel processor 12 and/or fuel cell stack 22. Similarly, in such an embodiment, the memory device may store performance data, threshold values, command signals and/or other programming for these other components as well.

For purposes of brevity, each of the variations of pressure regulator 80 will not be repeated in each description and illustration. Instead, it should be understood that it is within the scope of the disclosure that any of the feedstock delivery systems disclosed and/or illustrated herein may include any of the pressure regulators described herein. Similarly, delivery systems 17 according to the present disclosure may also include any of the pressurization assemblies, reservoirs, sources (of feedstock and/or pressurized gas), and delivery regulators, regardless of whether a particular combination of these elements is illustrated together.

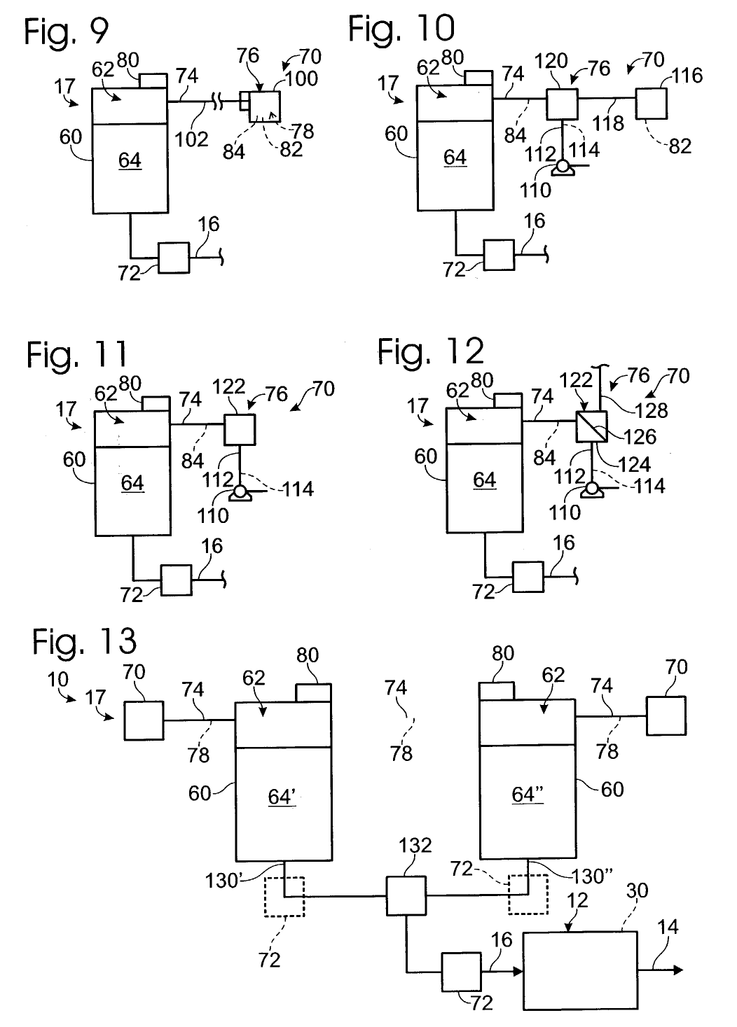

In FIG. 9, an example of a pressurization assembly 70 is shown in which source 76 is a tank or other pressurized vessel 100 containing gas 78. As discussed, in the context of a combustible carbon-containing feedstock 64, gas 78 may include an inert gas 82 and/or nitrogen-enriched or reduced-oxygen air 84. Tank 100 may be located at assembly 70, or may be in fluid connection therewith from a remote location by a supply line, as indicated schematically in FIG. 9 at 102. A benefit of source 76 being a tank containing gas 78 is that no compressors or mixing apparatus are required. Instead, stream 74 simply needs to be delivered to reservoir 60 from tank 100. However, the tank must contain a sufficient quantity of the gas and must periodically be replaced or recharged. Similarly, the tank will increase the size of system 17.

Another illustrative embodiment of a source 76 for stream 74 is shown in FIG. 10 and is adapted to produce nitrogen-enriched or reduced-oxygen air 84. As shown, source 76 includes a compressor 110 that is adapted to produce a pressurized stream 112 of air 114, and a tank 116 of nitrogen or other inert gas 82, which delivers a stream 118 of nitrogen gas to a manifold, or mixing region, 120, in which the streams are mixed to produce stream 74 of nitrogen-enriched air 84. Because a significant portion of stream 74, namely the portion formed by stream 112, is obtained from the environment surrounding assembly 70, it follows that this embodiment will require a smaller tank and/or less frequent recharging or replacement of the tank compared to the source illustrated in FIG. 9. It is within the scope of the disclosure that the system of FIG. 10 may introduce gases other than nitrogen gas to the stream of air. For example, other inert gases, namely, gases that will not support combustion or explosion of feedstock 64, may be used. As an illustrative example, chlorofluorocarbons such as HALON™ may be used. Another example is carbon dioxide.

Another example of a suitable source 76 for a nitrogen-enriched air stream is shown in FIG. 11. As shown, source 76 includes compressor 1110, which produces a pressurized stream 112 of air 114, similar to the system of FIG. 10. However, unlike the system of FIG. 10, in which nitrogen and/or other inert gases are added to a stream of air, the system of FIG. 11 is adapted to produce the stream of nitrogen-enriched (or reduced-oxygen) air 84 by removing oxygen from stream 112. As shown in FIG. 11, the pressurization assembly includes an oxygen-removal assembly 122, which includes any suitable structure or devices for removing oxygen from stream 112. For example, assembly 122 may remove oxygen by reacting the oxygen to form other compounds, or by absorbing the oxygen.

An example of another oxygen-removal assembly 122 is shown in FIG. 12 and includes a compartment, or enclosure, 124 that contains at least one oxygen-selective membrane 126. Suitable membranes and enclosures are available from Beko Membrane Technology, of Bend, Oreg. In use, air stream 112 is delivered under pressure to the compartment and into contact with membrane 126. At least a portion of the oxygen in the air passes through membrane 126 to form an oxygen-rich stream 128, with the portion of stream 112 that does not pass through the membrane forming stream 74 of nitrogen-enriched air 84. Depending, for example, upon the degree to which oxygen is removed from stream 112 and the acceptable oxygen content in stream 74, it is within the scope of the disclosure that a secondary air stream 112′ may be mixed with stream 74 prior to delivery to the reservoir. This variation increases the oxygen content in stream 74, but it may enable a higher flow rate of stream 74 than could otherwise be provided by the particular oxygen-removal assembly and/or compressor being used in source 76.

In FIG. 13, an example of a feedstock delivery system 17 is shown that includes more than one reservoir 60. In the illustrated embodiment, two reservoirs 60 are shown. It should be understood that system 17 may include more than two reservoirs as well, such as three, four, five, or more reservoirs. An example of a fuel processing assembly in which two or more reservoirs are desired is when the feed stream includes water and a carbon-containing feedstock that is not miscible with water, such as many hydrocarbons. However, the system of FIG. 13 may also be used with miscible feedstocks, such as water and an alcohol. Another example is when the delivery system includes redundant reservoirs, which enables the system to be used by drawing feedstock from less than all of the reservoirs, with others of the reservoirs being recharged, replaced and/or maintained without requiring the entire system to be inoperational. In the illustrated embodiment, the reservoirs each include a pressurization assembly 70 that is adapted to deliver a stream 74 of pressurized gas 78 to the respective reservoirs. As also shown in FIG. 13, each reservoir 60 further includes a pressure regulator 80. As discussed, the pressurization assemblies schematically illustrated in FIG. 13 and the subsequent figures may include any of the embodiments, subelements and/or variations disclosed and/or illustrated herein. The pressurized streams 130′ and 130″ of feedstock 64′ and 64″ from the reservoirs are mixed at a mixing structure 132 and delivered to fuel processor 12 as feed stream 16. Structure 132 may be any suitable manifold, chamber or other device in which the pressurized feedstocks may be mixed for delivery to the fuel processor as feed stream 16.

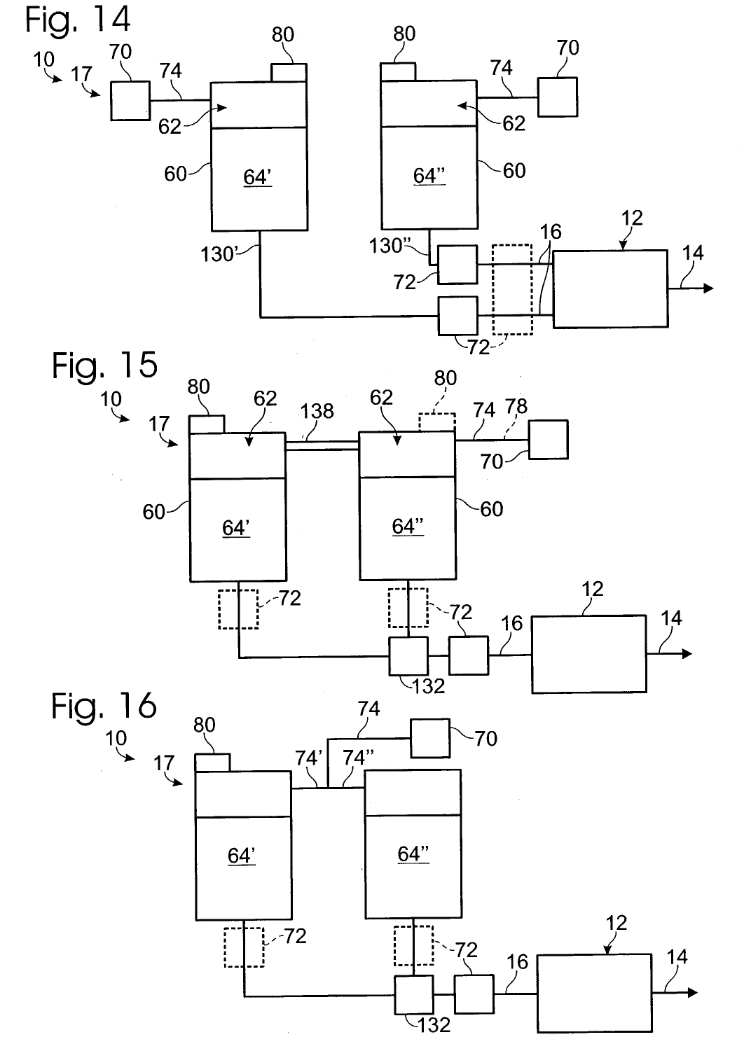

It is also within the scope of the disclosure that the pressurized streams of feedstocks 64′ and 64″ that form feed stream 16 may be separately delivered to fuel processor 12, such as shown in FIG. 14. In FIGS. 13 and 14, various illustrative positions for delivery regulator 72 have been shown to graphically illustrate that the flow regulator may be located at any selected position between compartments 62 of the reservoirs and fuel processor 12. Similarly, the delivery regulator, which is discussed in more detail subsequently, may have a separate region, or assembly, that is adapted to regulate the flow from each reservoir, or may regulate the streams after mixing.

Another example of a feedstock delivery system 17 that contains more than one reservoir 60 is shown in FIG. 15. Unlike the systems shown in FIGS. 13 and 14, however, in FIG. 15, the system does not include a separate pressurization assembly 70 for each reservoir. Instead, the reservoirs are linked by a conduit 138 through which the pressurized gas 78 may flow between the reservoirs to equalize the pressure in the reservoirs. Preferably, conduit 138 is selected to have at most a relatively small pressure drop. A benefit of this embodiment is that it does not require the additional equipment, space, maintenance and expense of more than one pressurization assembly. Instead, the single pressurization assembly pressurizes each of the two or more reservoirs. Furthermore, because the reservoirs are open to each other, meaning that gas 78 may flow between the tanks to equalize the pressures therein, the feedstocks supplied by the reservoirs will be at the same pressure. Similarly, because the pressure of each reservoir is the same, it is within the scope of such an embodiment that the reservoirs may include a single pressure regulator, thereby further reducing the required equipment and expense compared to an embodiment in which each reservoir has its own pressure regulator. It should be understood that this latter scenario, in which each reservoir has its own pressure regulator, is also within the scope of the disclosure.

In FIG. 16, a variation of the system shown in FIG. 15 is shown. In FIG. 16, the system includes two (or more) reservoirs. However, instead of sequentially connecting the reservoirs together with a conduit 138, the pressurization assembly is adapted to deliver streams 74′ and 74″ directly to each of the reservoirs. As discussed, pressurization assembly 70 may include any of the previously discussed and/or illustrated structures, including sources 76 that include pressurized tanks, compressors with oxygen-removal assemblies, oxygen-selective membranes, etc.

As also discussed, feedstock delivery system 17 includes a delivery regulator 72 that controls the delivery of feed stream 16 to fuel processor 12. Typically, the flow rate of feed stream 16 is one liter per minute or less, with common feed rates for fuel processors in the form of steam reformers associated with 1-3 kW fuel cell stacks being approximately 100 mL/minute, such as in the range of 20-100 mL/minute. However, it should be understood that the rate at which feed stream 16 is delivered to fuel processor 12 Will vary at least in part responsive to the type of fuel processor and the size of the fuel processor. As such, the above flow rates should be understood to provide illustrative examples of suitable feed rates, but it is within the scope of the disclosure that system 17 may be configured to provide larger or smaller feed rates.

Because the feedstock(s), and therefore feed stream 16, are supplied under pressure from one or more reservoirs 60, delivery regulator 72 does not require a pump to draw feedstock from the reservoir(s) or to pressurize the feedstock to the desired delivery pressure for fuel processor 12. As such, delivery regulator 72 may be referred to as a pumpless delivery regulator. Similarly, the feedstock delivery system may be described as being adapted to deliver feed stream 16 (or a component thereof) under pressure from reservoir 60 to the fuel processor without requiring a pump to do so. It is within the scope of the disclosure that any of the delivery regulators described and/or illustrated herein may be used with any of the feedstock delivery systems described or illustrated herein, including any of the pressure regulators and any of the pressurization assemblies described and/or illustrated herein. It is further within the scope of the disclosure that the pressurization assemblies and reservoirs described herein may be implemented With any other suitable structure for selectively delivering the feedstock to the fuel processor.

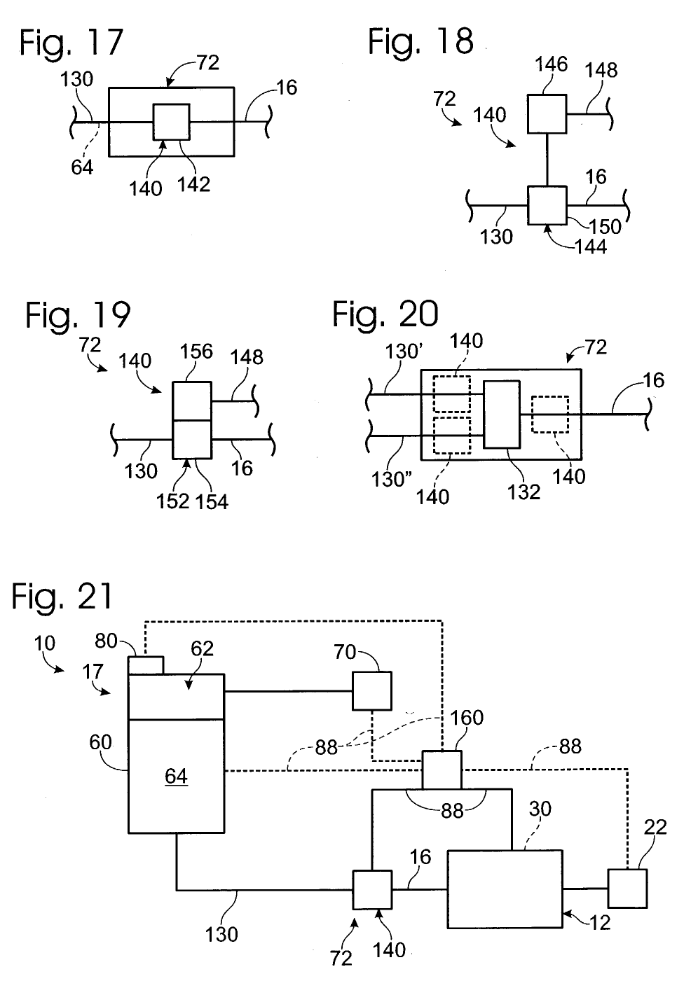

Regulator 72 includes a valve assembly 140 that includes at least one valve 142 or other suitable mechanism for selectively stopping and permitting flow of feedstock(s) 64 through the one or more fluid delivery conduits to fuel processor 12. Examples of suitable valves include manually operated valves, as well as electronically (or otherwise automatically) actuated valves, such as solenoid valves, throttle valves in communication with a servo motor, etc. An example of a delivery regulator 72 with a valve assembly 140 is schematically illustrated in FIG. 17. For the purpose of simplifying the drawing, regulator 72 is shown receiving a stream 130 of pressurized feedstock 64 and outputting feed stream 16. In FIG. 18, valve assembly 140 is shown including a solenoid valve 144. Valve 144 includes a solenoid, or coil, portion 146 that is adapted to receive a control signal, such as via any suitable wired or wireless communication linkage 148, and responsive to this control signal controlling the position of a valve portion 150 that regulates the flow of feedstock, if any, through the valve. Valve 144 selectively actuates the valve between its closed and fully open positions, and optionally between one or more predetermined positions within this range. An example of a control mechanism for valve 144 is through pulse width modulation, although other mechanisms may be used. In FIG. 19, valve assembly 140 is shown including a throttle valve 152 that includes a valve portion 154 and a servo motor, or other actuator, 156 that is adapted to control the position of the valve portion responsive to a control signal, such as via linkage 148.

In embodiments of the delivery system that include more than one reservoir, it is within the scope of the disclosure that regulator 72 may be (but is not necessarily) integrated with mixing structure 132, such as schematically illustrated in FIG. 20. FIG. 20 also graphically illustrates that valve assembly 140 may regulate the flow, or relative rate of flow, of the pressurized feedstocks either prior to, Or after, mixing. It is further within the scope of the disclosure that the regulator may include separate components that regulate the flow of each pressurized stream of feedstock, such as prior to mixing, or also in embodiments in which the feedstocks are not mixed prior to delivery to fuel processor 12.

Preferably, but not necessarily, the regulator also includes a mechanism for regulating the relative rate of flow of the feedstock in feed stream 16. This flow regulation may be in predetermined increments between a closed position, in which there is no flow, and a fully open position, in which the valve assembly is configured to permit the maximum flow of feedstock therethrough. Alternatively, the flow regulation may enable the flow rate to be selected anywhere within the closed and fully open positions. For example, the orifice, or passage, through a throttle valve may be selectively controlled between the closed and fully open positions responsive to the degree of actuation of the valve's controller. Solenoid valves, however, typically are only configured in closed and fully open positions, and in some embodiments, within predetermined increments between these positions. As illustrated by the above discussion, the flow regulation may be provided by the valve assembly, such as by the valve or valves that define the closed and fully open positions or by other valves within the assembly. As another example, the delivery regulator may additionally or alternatively include one or more orifices that are sized to define a particular rate of flow therethrough, thereby establishing an upper threshold, or bound, on the relative rate of flow of feed stream 16.

As discussed, it is within the scope of the disclosure that delivery regulator 72 may be manually actuated, such as by one or more user-actuated levers, dials, and the like. However, at least portions of regulator 72 are preferably automated, and therefore do not require an operator to be available to manually control the delivery regulator. In an automated embodiment, an example of which is shown in FIG. 21, the regulator includes, or communicates with, a controller 160 that is adapted to send control signals to the valve assembly and/or other flow-regulating structure of the delivery regulator responsive at least in part to one or more of user inputs, measured operating parameters of the delivery system and/or the fuel processing or fuel cell system, and/or predetermined operating parameters and instructions, such as may be stored in a memory device associated with a processor of the controller. In embodiments of the delivery system that also include a pressurization assembly with a controller and/or a sensor assembly with a controller, these controllers may be, but are not required to be, at least partially, or completely, integrated together. Similarly, one or more of the controllers may be integrated with controllers that are adapted to control the operation of other components of the fuel processing or fuel cell system.

### INDUSTRIAL APPLICABILITY

The disclosed feedstock delivery system is applicable to the fuel processing and fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous Variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A fuel processing system, comprising:
a fuel processor adapted to receive a feed stream containing at least one feedstock and to produce a mixed gas stream containing hydrogen gas therefrom; and
a feedstock delivery system adapted to deliver the feed stream to the fuel processor, the feedstock delivery system comprising:
a feedstock reservoir having a compartment adapted to store under pressure in a liquid phase a volume of a carbon-containing feedstock;
a pressurization assembly adapted to pressurize the reservoir by delivering a pressurized gas stream to the compartment of the reservoir; and
a delivery regulator adapted to regulate the delivery of the feedstock from the reservoir to the fuel processor.

2. The fuel processing system of claim 1, wherein the pressurized gas stream is at least substantially comprised of nitrogen gas.

3. The fuel processing system of claim 1, wherein the pressurized gas stream is at least substantially comprised of an inert gas.

4. The fuel processing system of claim 1, wherein the pressurized gas stream is a nitrogen-enriched air stream.

5. The fuel processing system of claim 1, wherein the pressurization assembly is adapted to deliver into the compartment a pressurized gas stream having insufficient oxygen for the feedstock in the compartment to be flammable or explosive when stored under pressure in the compartment.

6. The fuel processing system of claim 1, wherein the reservoir is further adapted to receive and store in the compartment water along with the carbon-containing feedstock.

7. The fuel processing system of claim 1, wherein the pressurization assembly includes a source of the pressurized gas stream.

8. The fuel processing system of claim 7, wherein the source of the pressurized gas stream is adapted to receive an air stream and to produce a nitrogen-enriched air stream therefrom, and further wherein the nitrogen-enriched air stream forms at least a portion of the pressurized gas stream.

9. The fuel processing system of claim 8, wherein the pressurized gas stream is completely formed from the nitrogen-enriched air stream.

10. The fuel processing system of claim 8, wherein the pressurized gas stream comprises at least a portion of the nitrogen-enriched air stream and at least a portion of a second gas stream selected from the group consisting of an air stream, nitrogen gas, a combustion-inhibiting gas and an inert gas.

11. The fuel processing system of claim 8, wherein the source of the pressurized gas stream includes an oxygen-removal assembly that is adapted to reduce the concentration of oxygen gas in the air stream received by the source of the pressurized gas stream.

12. The fuel processing system of claim 11, wherein the oxygen-removal assembly is adapted to reduce the concentration of oxygen gas in the air stream by chemically reacting at least a portion of the oxygen gas.

13. The fuel processing system of claim 11, wherein the oxygen-removal assembly is adapted to reduce the concentration of oxygen gas in the air stream by absorbing at least a portion of the oxygen gas.

14. The fuel processing system of claim 11, wherein the oxygen-removal assembly is adapted to reduce the concentration of oxygen gas in the air stream by separating from the air stream an oxygen-rich stream containing a higher concentration of oxygen gas than the air stream.

15. The fuel processing system of claim 11, wherein the oxygen-removal assembly includes at least one oxygen-selective membrane, and further wherein the oxygen-removal assembly is adapted to deliver the air stream into contact with the at least one oxygen-selective membrane, with the nitrogen-enriched air stream being formed from a portion of the air stream that does not pass through the at least one oxygen-selective membrane.

16. The fuel processing system of claim 1, wherein the pressurization assembly is adapted to maintain the pressure within the reservoir at a pressure of at least 25 psig.

17. The fuel processing system of claim 16, wherein the pressurization assembly is adapted to maintain the pressure within the reservoir at a pressure of at least 50 psig.

18. The fuel processing system of claim 16, wherein the pressurization assembly is adapted to maintain the pressure within the reservoir at a pressure in the range of 100-300 psig.

19. The fuel processing system of claim 1, wherein the pressurization assembly includes a pressure regulator that is adapted to regulate the pressure in the compartment.

20. The fuel processing system of claim 1, wherein the feedstock delivery system further includes at least one oxygen sensor adapted to measure the concentration of oxygen gas in at least one of the pressurized gas stream and the compartment of the reservoir.

21. The fuel processing system of claim 20, wherein the feedstock delivery system is adapted to reduce the pressure in the compartment upon detection of a concentration of oxygen gas in at least one of the compartment and the pressurized gas stream that exceeds a determined threshold value.

22. The fuel processing system of claim 20, wherein the fuel processing system is adapted to shutdown the fuel processor upon detection of a concentration of oxygen gas in at least one of the compartment and the pressurized gas stream that exceeds a determined threshold value.

23. The fuel processing system of claim 20, wherein the feedstock delivery system includes an exhaust assembly that is adapted to introduce an exhaust gas stream into the compartment upon detection of a concentration of oxygen gas in at least one of the compartment and the pressurized gas stream that exceeds a determined threshold value.

24. The fuel processing system of claim 23, wherein the exhaust gas stream is at least substantially comprised of at least one of an inert gas and a combustion-inhibiting gas.

25. The fuel processing system of claim 20, wherein the feedstock delivery system includes at least one oxygen sensor adapted to measure the concentration of oxygen gas in the compartment of the reservoir.

26. The fuel processing system of claim 1, wherein the feedstock delivery system includes a pressure sensor adapted to measure the pressure within the compartment of the reservoir, and further wherein upon detection that the pressure within the compartment is below a determined threshold value, the pressurization assembly is adapted to increase the pressure within the compartment.

27. The fuel processing system of claim 1, wherein the delivery regulator is a pumpless delivery regulator that is adapted to deliver the feedstock from the reservoir to the fuel processor without utilizing a pump.

28. The fuel processing system of claim 27, wherein the delivery regulator includes a Valve assembly that selectively controls the flow of the feedstock from the reservoir to the fuel processor.

29. The fuel processing system of claim 28, wherein the valve assembly includes at least one pulse width modulation controlled solenoid valve.

30. The fuel processing system of claim 28, wherein the valve assembly further includes at least one servo motor controlled throttle valve.

31. The fuel processing system of claim 1, wherein the feedstock delivery system includes a plurality of reservoirs.

32. The fuel processing system of claim 31, wherein the feedstock delivery system includes a gas conduit through which the pressurized gas stream may flow between the plurality of reservoirs.

33. The fuel processing system of claim 32, wherein the gas conduit is adapted to equalize the pressure within the plurality of reservoirs.

34. The fuel processing system of claim 31, wherein the plurality of reservoirs are adapted to receive different feedstocks and further wherein the feedstock delivery system includes a mixing structure adapted to receive flows of the feedstocks from the plurality of reservoirs and to produce a feed stream for the fuel processor therefrom.

35. The fuel processing system of claim 1, wherein the fuel processor is adapted to produce the mixed gas stream by steam reforming.

36. The fuel processing system of claim 1, wherein the fuel processor is adapted to produce the mixed gas stream by a selected one of partial oxidation, pyrolysis and autothermal reforming.

37. The fuel processing system of claim 1, wherein the fuel processor includes a separation region adapted to receive the mixed gas stream and to produce a hydrogen-rich stream therefrom having a greater concentration of hydrogen gas than the mixed gas stream.

38. The fuel processing system of claim 37, wherein the separation region includes at least one hydrogen-selective membrane and further wherein the hydrogen-rich stream is formed from the portion of the mixed gas stream that passes through the membrane.

39. The fuel processing system of claim 37, wherein the separation region is adapted to produce the hydrogen-rich stream via a pressure swing adsorption process.

40. The fuel processing system of claim 1 >in combination with a fuel cell stack adapted to receive at least a portion of the mixed gas stream and to produce an electric current therefrom.

41. A fuel processing system, comprising:
a fuel processor adapted to receive a feed stream containing at least one feedstock and to produce a mixed gas stream containing hydrogen gas therefrom; and
a feedstock reservoir having a compartment adapted to store under pressure in a liquid phase a volume of a carbon-containing feedstock;
means for pressurizing the reservoir with a pressurized gas stream containing nitrogen-enriched air;
means for delivering the feedstock from the reservoir to the fuel processor.

42. The fuel processing system of claim 41, wherein the means for pressurizing is adapted to receive an air stream and to produce a stream of nitrogen-enriched air therefrom.

43. The fuel processing system of claim 42, wherein the means for pressurizing includes at least one oxygen-selective membrane.

44. The fuel processing system of claim 41, wherein the means for pressurizing is adapted to deliver into the compartment a pressurized gas stream having insufficient oxygen for the feedstock in the compartment to be flammable or explosive when stored under pressure in the compartment.

45. The fuel processing system of claim 41, wherein the means for delivering is a pumpless means for delivering that is adapted to deliver the feedstock from the reservoir to the fuel processor without utilizing a pump.

46. The fuel processing system of claim 41, wherein the fuel processor is adapted to produce the mixed gas stream by steam reforming.

47. The fuel processing system of claim 41, wherein the fuel processor is adapted to produce the mixed gas stream by a selected one of partial oxidation, pyrolysis and autothermal reforming.

48. The fuel processing system of claim 41, wherein the fuel processor includes a separation region adapted to receive the mixed gas stream and to produce a hydrogen-rich stream therefrom having a greater concentration of hydrogen gas than the mixed gas stream.

49. The fuel processing system of claim 48, wherein the separation region includes at least one hydrogen-selective membrane and further wherein the hydrogen-rich stream is formed from the portion of the mixed gas stream that passes through the membrane.

50. The fuel processing system of claim 48, wherein the separation region is adapted to produce the hydrogen-rich stream via a pressure swing adsorption process.

51. A fuel processing system, comprising:
a fuel processor adapted to receive a feed stream containing at least one feedstock and to produce a mixed gas stream containing hydrogen gas therefrom;
a feedstock reservoir having a compartment in which a liquid-phase carbon-containing feedstock is stored under pressure, wherein the compartment further includes a volume of gas that includes at least one of the group of nitrogen-enriched air, an inert gas, and a combustion-inhibiting gas; and
a pumpless delivery regulator adapted to regulate the delivery of the feedstock from the reservoir to the fuel processor.

52. The fuel processing system of claim 51, wherein the volume of gas contains insufficient oxygen for the feedstock in the compartment to be flammable or explosive in the compartment.

53. The fuel processing system of claim 51, wherein the compartment further contains water.

54. The fuel processing system of claim 53, wherein the fuel processor is adapted to produce the mixed gas stream by steam reforming.

55. The fuel processing system of claim 51, wherein the reservoir is a first reservoir, wherein the system further comprises a second feedstock reservoir having a compartment in which a liquid-phase feedstock is stored under pressure, wherein the compartment of the second reservoir further includes a volume of gas that includes at least one of the group consisting of nitrogen-enriched air, an inert gas, and a combustion-inhibiting gas.

56. The fuel processing system of claim 55, wherein the first and the second reservoirs are interconnected by a gas conduit through which the volume of gas may flow.

57. The fuel processing system of claim 55, wherein the liquid-phase feedstock in the second reservoir includes water.
